(19) United States
(12) Patent Application Publication
(10) Pub. No.: US 2023/0323652 A1
(43) Pub. Date: Oct. 12, 2023

(54) MODULAR FOLDABLE BUILDING SYSTEM AND METHOD

(71) Applicant: Peter Gibb Cropper Nemiroff, New Canaan, CT (US)

(72) Inventor: Peter Gibb Cropper Nemiroff, New Canaan, CT (US)

(21) Appl. No.: 18/042,846

(22) PCT Filed: Aug. 23, 2021
(86) PCT No.: PCT/US21/71253

§ 371 Date: Feb. 24, 2023

Related U.S. Application Data
(60) Provisional application No. 63/069,167, filed on Aug. 24, 2020.

(51) Int. Cl. E04B 1/344; E04B 1/343; E04B 1/348

(52) U.S. Cl. CPC E04B 1/3445; E04B 1/34384; E04B 1/34815; E04B 2001/34389

(57) ABSTRACT

This invention provides a modular folding building structure having at least one room unit assembled from two foldable modules that are coupled together and a roof. Room units can be used singly or ganged together to form multiroom structures. Each room unit has a floor that may include floor panels or floor planks supported by a floor frame. The walls on each foldable module are connected to a base with hinges, such that each room module has a storage position in which the walls are folded down parallel to the floor. Each module also has an erect position in which the walls are unfolded to a vertical orientation perpendicular to the floor by rotating a wall around the hinges. The walls may be solid with wall panels and appropriate openings for doors, windows, and in-wall air-conditioning. Alternatively, the walls may be substantially openings.

### CROSS-REFERENCE TO RELATED APPLICATIONS

This patent application claims benefit of U.S. Provisional Patent Application 63/069,167 filed Aug. 24, 2020, which is incorporated by reference herein.

### FIELD OF THE INVENTION

The present invention relates to modular building systems and to modular structures that are easily stored, movable, and foldable, as well as a method for installation of modular foldable structures.

### BACKGROUND OF THE INVENTION

There are many situations where transportable and customizable buildings are urgently needed for housing and commercial purposes. Under different circumstances, it may be desirable to provide movable buildings for people and/or equipment. For instance, it may be desirable to provide temporary hospitals that can be transported easily and assembled and disassembled promptly as necessary.

It may be desirable to have buildings that can be assembled by a limited number of people and with a relatively easy assembly process and minimal equipment, while providing structural strength and adequate protection from weather-related elements. For example, hospitals or housing “villages” might be required in response to wide-spread diseases and in response to natural disasters. In urgent or life-threatening instances, the available time for assembly and disassembly of such construction is short and thus, the time spent on these tasks must be minimal.

Such constructions also need to be easy to transport, reusable, convenient to store and assemble, and cost efficient.

In the past, tents or prefabricated mobile homes have been widely used. Tents, however, are an inadequate solution for prolonged use and/or use in adverse weather conditions. In addition, tents do not provide adequate security due to their fragile consistency and are easily subject to wear and tear particularly when overexposed to adverse weather conditions. While mobile homes provide a limited solution to the problems this invention resolves, mobile homes are not flexible in size, are difficult and expensive to transport and store, and are not customizable on demand in emergency situations.

Other modular building structures have the required strength and stiffness but are difficult to assemble and are not reusable. For instance, U.S. Pat. No. 10,480,176 to Unger discloses a modular building system, where multiple box-like frames can be connected to form a larger structure. Also, U.S. Pat. No. 8,186,115 to Harig et al., discloses a modular wall panel system. These modular folding structures however cannot be easily assembled and disassembled or customized multiple times depending on the needs, as well as transported, stored, and reused. U.S. Pat. No. 10,577,174 to Fenneman and Hatcher discloses a folding system for intermodal shipping containers, but without the modular features of the instant invention.

An additional drawback is that the existing modular structures that are currently in the market are costly to manufacture and transport.

Therefore, the market needs a modular folding structure system having the advantages discussed above. The scalable modular structure of the present invention may become a valuable tool for first responders and victims of national crisis because such structure would help people in need and can be easily transported, assembled, disassembled, stored or used in another location, while providing adequate protection against the elements.

### SUMMARY OF THE INVENTION

The present invention relates to a modular foldable structure that can be used to provide various services, including housing, equipment storage and others. The structure can be a single unit structure or a multi-unit structure, where each unit is formed by complimentary modules with foldable and/or detachable panels. In the present description, the term “module” includes a base, a floor panel covering the base, a front wall, or a rear wall and/or one or more side wall panels. Two complimentary modules and a roof form a “unit”, which can form an enclosed or a habitable space. In this invention, a modular structure can vary in size. A single unit can form a structure with a single habitable space or room. When assembled together multiple units form multi-unit structures, which can have multiple enclosed spaces or rooms. The term “habitable space” is used interchangeably with the term “enclosed space” and is understood to include, hallways, bathrooms, utility spaces, closets or similar areas.

Because of its portable modular and foldable design, the structure can be rapidly deployed to any location and transported over ocean, land, or air using truck, rail, aircraft or water vessels. The innovative design allows portability and easy assembly. The structure is compact when folded, inexpensive to store and is reusable. It can be promptly disassembled and shipped to another location if necessary. Its reusable feature as well as compact packaging, makes it also eco-friendly as it avoids unnecessary waste and fuel costs.

In order to accomplish these purposes, an embodiment of a modular foldable building structure (10) is provided including at least one room unit (100) having a first foldable module (100′) and a second foldable module (100″), wherein each module has a storage position (238) and an erected position (FIG. 2), and each module has a base (110′, 110″) with a square or rectangular shape with an interior edge (224′, 224″) and three exterior edges (225′, 225″, 226′, 226″, 227′, 227″), and a floor panel (120′, 120″) covering each module base, wherein each interior edge (224′, 224″) of the base is a joinable edge parallel to the exterior edge (225′, 225″) of the same module; wherein an optional multifold wall panel (130) is hingeably attached to each exterior edge (225′, 225″), wherein the axis of the multifold wall is parallel to the floor such that the multifold wall panel, if present, folds towards the joinable edge (224′, 224″) in the storage position and unfolds in the erect position to define a right angle between the floor and front wall panel; wherein an exterior edge (226′, 226″, 227′, 227″) is a side edge of the square or rectangular shaped module wherein a side wall panel (140′, 140″, 160′, 160″) is hingeably connected to a side edge (226′, 226″, 227′, 227″), such that each side wall panel lays flat along the base in the storage position (238), and in an erected position, each side wall panel pivots upwards around the hinge to define a right angle between the floor and the wall panel; wherein the first foldable module (100′) in the erected position and the second foldable module (100″) in the erected position are configured to couple together along the joinable edge (224′, 224″) of each module to form a room unit (100) with a rectangular or square-shaped floor, and wherein a roof (200) that at least covers the floor (120) is affixed to a roof support member (177), to form a modular folding building structure.

In another embodiment, a modular foldable building structure is provided including at least one room unit (10) having a first foldable module (100′) and second foldable module (100″), wherein each module has a storage position (238) and an erected position (FIG. 2), and each module has a base (110′, 110″) with a rectangular shape with two long edges (224′, 224″, 225′, 225″) and two shorter edges (227′, 227″), a floor panel (120′, 120″) covering each module base, wherein one long edge of each base may be a joinable edge (224′, 224″) and the other long edge of the base defines a long exterior edge (225′, 225″). Each short edge (227′, 227″) may have a side wall panel (140′, 140″, 160′, 160″) hingeably connected to a short edge, such that each side wall panel lays flat along the base in the storage position (238) and in an erected position, each side wall panel pivots upwards around the hinge to define a right angle between the floor and the side wall panel. An optional bifold wall panel (130) may be hingeably attached to the exterior long edge (225′, 225″) of either module wherein the axis of the bifold is parallel to the floor, such that the bifold wall panel, if present, folds towards the joinable edge (224′, 224″) in the storage position and unfolds in the erect position to define a right angle between the floor and front wall panel in the erect position. The first foldable module (100′) in the erected position and the second foldable module (100″) in the erected position may be configured to couple together along the joinable edge (224′, 224″) of each module to form a unit body (100) with a rectangular or square-shaped floor, and wherein a roof (200) that at least covers the floor (120) is affixed to a support beam (177), to form a modular folding building structure.

In another embodiment, a modular foldable building structure (10) is provided having at least one room unit (100) having a first foldable module (100′) and a second foldable module (100″), wherein each module has a storage position (238) and an erected position (FIG. 2), and each module has a base (110′, 110″) with a square or rectangular shape with an interior edge (224′, 224″) and three exterior edges (225′, 225″, 226′, 226″, 227′, 227″), and a floor panel (120′, 120″) covering each module base, wherein each interior edge (224′, 224″) of the base is a joinable edge parallel to the exterior edge (225′, 225″) of the same module; wherein each side edge (226′, 226″, 227′, 227″) may have a side wall panel (140′, 140″, 160′, 160″) hingeably connected thereto, such that each side wall, if present, lays flat along the base in the storage position (238) and in an erected position, each side wall pivots upwards around the hinge to define a right angle between the floor and the wall, and wherein each module (100′ or 100″) has at least two side walls panels (140′, 140″, 160′, 160″); wherein an optional bifold wall (130) is hingeably attached to the exterior long edge (225′, 225″) of either module wherein the axis of the bifold is parallel to the floor, such that the bifold wall panel, if present, folds towards the joinable edge (224′, 224″) in the storage position and unfolds in the erect position to define a right angle between the floor and front wall panel in the erect position; and
wherein the first foldable module (100′) in the erected position and the second foldable module (100″) in the erected position are configured to couple together along the joinable edge (224′, 224″) of each module to form a unit body (100) with a rectangular or square-shaped floor, and wherein a roof (200) that at least covers the floor (120) is affixed to a support member (177), to form a modular folding building structure.

In another embodiment, a modular foldable building structure (30) is provided having a room unit having a first and second foldable module (100′, 100″) having a storage position (238) and an erected position, where each module has a first module base (110′, 110″) having a rectangular shape with two long edges (224′, 224″, 225′, 225″) and two shorter edges (226′, 226″, 227′, 227″), a floor panel covering the first module base, wherein one long edge of each base is a joinable interior edge (224′, 224″) and the other long edge of the base defines a long exterior edge (225′, 225″) with two exterior corners (269), wherein each short edge (226′, 226″,227′, 227″) has an open side wall (240) hingeably connected to the corner (269) of the short edge, such that the side wall lays flat along the base in the storage position, and each side wall pivots upward in the erected position to define a right angle between the base and the wall when erect, and wherein the side wall (240) has a vertical support member (241) and an upper side panel (242). The first foldable module in the erected position and the second foldable module in the erected position may be configured to couple together along the interior edge (224) of each module to form a unit body 100 with a rectangular or square-shaped floor, and a long edge upper panel (243) is placed between the two upper side panels (242), and wherein a roof (200) that at least covers the floor (120) is affixed to a support beam (177), to form a modular foldable building structure.

In an embodiment, a modular foldable building structure is provided, wherein the roof (200) comprises one or more roof panels (200′, 200″), and said roof panels are mounted on the room unit to form a habitable space with at least one door opening.

In an embodiment, a modular foldable building is provided, wherein the support beam is an I-beam (117a).

In an embodiment, a modular foldable building is provided, wherein the support beam is a hollow tube (117b) having at least a flat surface on the top affixable to the roof panels.

In an embodiment, a modular foldable building is provided, wherein the roof panels are supported by two or more trusses (177c).

In an embodiment, a modular foldable building is provided, wherein the coupling of the first and second modules along the joinable edge (224) to form the room unit further comprises at least one joining part (162) having a bolt and nut (161) to fasten the two modules together.

In an embodiment, a modular foldable building is provided, wherein any wall (130, 140, 150, 160) further comprises a frame made of steel tubing, wood, rigid plastic or another suitable construction material. Any wall may also comprise a panel made of wood, sheet metal, rigid plastic, or other suitable construction materials.

In an embodiment, a modular foldable building is provided, wherein adjacent wall panels are connected together with at least one bolt (164) and nut.

In an embodiment, a modular foldable building is provided, wherein the hinges for each side wall comprise two outer knuckles affixed to the base, and an inner knuckle affixed to the wall, and pin through the knuckles.

In an embodiment, a modular foldable building is provided, wherein the first or second module or both has a wall affixed to the long exterior edge wherein the wall comprises one or more horizontal panels connected to each other by hinge mechanisms, said plurality of horizontal panels fold and unfold with respect to each other along a horizontal axis.

In an embodiment, a modular foldable building is provided, wherein each wall is joined to another wall to form a corner, wherein the joint comprises at least one bolt, and the joined walls are locked into position.

In an embodiment, a modular foldable building is provided having a plurality of interconnected foldable room units according to claim 1, wherein one or more joined short edges (232) can be joined to form a plurality of interconnected foldable units.

In an embodiment, a modular foldable building is provided, wherein one or more long edges (234) can be joined to form a plurality of interconnected foldable units.

In an embodiment, a modular foldable building is provided, wherein a wall has a window or door opening (158).

In an embodiment, a modular foldable building is provided, wherein a wall has large opening (236) and an upper panel (237).

In an embodiment, a modular foldable building is provided, wherein each wall has a frame (170) and one or more solid panels.

In an embodiment, a modular foldable building is provided, wherein the floor of each module has a frame (123) and may have one or more solid floor panels (120).

In an embodiment, a modular foldable building is provided, wherein the floor and walls may be insulated.

In an embodiment, a modular foldable building is provided, wherein an opening may be provided in a wall section for air conditioning unit, and the air conditioning unit can cool or heat the air in the room unit.

In an embodiment, a modular foldable building may be provided, wherein electrical outlets and plumbing fixtures are provided.

In an embodiment, a modular foldable building is provided further comprising one or more walls coupled to the first or the second module walls that may extend the height of the structure.

In an embodiment, a modular foldable building is provided, wherein the structural members and all floor, wall, and roof panels are made from a material selected from steel, wood, or plastic or other suitable construction material.

In an embodiment, a modular foldable building is provided, wherein each module may be sufficiently light weight that it can be carried into position by a team of two to six people.

In an embodiment, a method of assembling a modular foldable unit is provided, comprising the steps of:
a. Placing the first folded module at the desired position with the first module base facing the ground with or without supports on the ground or a foundation;
b. pivoting upwards (230) each wall panel of the first module to a vertical erected position and securing each erected wall panel at its erected position;
c. placing a second module of a unit in contact with the first module, wherein the second module floor is level with the first module floor and is facing the ground with or without supports on the ground or a foundation;
d. pivoting upwards the wall panels of the second module to a vertical erected position and securing the wall panels at the erected position;
e. attaching the first module to the second module by attaching each side wall panel of the first module to an adjacent side wall panel of the second module;
f. installing a roof supporting member into a pocket formed by the attachment of the side wall panel of the first module to the adjacent side wall panel of the second module;
g. attaching the roof panels to the roof supporting member.

An objective of the present invention is to provide a structure that can be used anywhere, under various weather conditions. The modular building system subject to this invention may be eligible for a Risk IV Category structure certification and can withstand a Category 4 Hurricane (155 miles per hour), as well as roof snow loads of 50 lbs./sq.ft., may be a Seismic Design Category C, and meets IBC 2015 with ASCE-7-10 classifications for a structure.

Another objective of the present invention is to provide a customizable structure at a low transport, manufacture and assembly costs.

Another objective of the present invention is to provide pre-manufactured components for a customizable structure that may be carried by two to four persons, for example from a delivery truck to a building location without the use of a forklift.

In one aspect, the present invention provides for a single unit box-shaped modular structure formed by two complimentary modules.

In another aspect, the present invention provides for a multi-unit modular structure that includes a variety of modules, which can be coupled together to form habitable, storage and/or other units, which once joined together form a multi-unit structure. Thus, a modular structure can be either a single unit structure or a multi-unit structure. The units themselves are versatile as they can be joined to form a large variety of modular structures from a single row, multiple rows, branched or multi-storied structures. Modules can be easily added or removed depending on the required specifications to conform habitable, storage and/or other enclosed spaces.

The module foldability allows the entire modular structure to be disassembled and folded into compact “shipping units”, each shipping unit comprising a module, which allows for multiple shipping units to be stacked on top of each other and shipped together over ocean, land, or air using truck, rail, plane or water vessel at a lower cost.

Another advantage of the present invention is that the parts of a module may be attached together during assembly, disassembly, and transport to ensure that nothing gets misplaced and to ensure the parts are unloaded and moved with ease until they reach the desired final positions.

In addition, having parts of a module attached to each other significantly speeds up the process of assembly and disassembly which saves time and labor costs.

### DESCRIPTION OF THE DRAWINGS

FIG. 1A is a perspective front view of an exemplary modular building structure in accordance with an embodiment of the disclosure.

FIG. 1B is a perspective back view of the exemplary modular building structure depicted in FIG. 1A.

FIG. 1C is an isometric view of a simple embodiment of a modular building structure according to this invention having a door and window and four walls.

FIG. 2 is an exploded perspective view of two complementary modules showing how they fit together to form a room unit such as in FIG. 1.

FIG. 3 is an enlarged cross-sectional view illustrating the joining assembly of adjacent panels.

FIG. 4 is an enlarged cross-sectional view depicting an exemplary corner panel joining assembly of a module.

FIG. 5A is a perspective view of a module base.

FIG. 5B is an exploded view of the parts of a hinge attached to the outer long edge of the base.

FIG. 5C is an exploded view of the parts of a hinge attached to a short edge of the base.

FIG. 6 is an isometric view of a typical hinge used in this invention.

FIG. 7A shows a module in its folded position suitable for transportation.

FIG. 7B shows a module with a side panel erected.

FIG. 7C depicts a module in semi-unfolded position with two side panels erected.

FIG. 7D depicts the unfolding of a horizontal panels wall according to an embodiment of the present invention.

FIG. 8A is a cross section showing wall, base, and floor of a module with a recessed hinge.

FIG. 8B is a cross section showing a different wall than FIG. 8A, base, and floor of a module with a recessed hinge.

FIG. 8C is a cross section view showing a bifold wall with recessed hinges attached to a base.

FIG. 8D is a cross section view of the same parts shown in FIG. 8A, but folded over.

FIG. 9 is an isometric view of a folded module including a roof panel.

FIG. 10 is an elevation view of the long side of the folded module shown in FIG. 9.

FIG. 11 is a perspective view of stacked modules.

FIG. 12A is a perspective front view of an exemplary corner unit.

FIG. 12B is a perspective back view of the unit depicted in FIG. 12A.

FIG. 13A is a perspective front view of an exemplary modular internal hallway unit in accordance with an embodiment of the disclosure.

FIG. 13B is a perspective back view of the exemplary unit depicted in FIG. 13A.

FIG. 14A is a perspective front view of an exemplary modular external hallway unit in accordance with an embodiment of the disclosure.

FIG. 14B is a perspective back view of the exemplary unit depicted in FIG. 14A.

FIG. 15A is a perspective view of an I-beam seated in the pocket formed between two adjacent panels of a wall frame.

FIG. 15B is an enlarged detail perspective view of the pocket and linkage shown in FIG. 15A.

FIG. 15C is a perspective exploded view of a rectangular steel tube roof support beam in relation to the pocket formed between two adjacent panels of a wall frame.

FIG. 15D is a perspective exploded view of a truss and the pocket formed between two adjacent panels of a wall frame.

FIG. 16 shows an exemplary external wall panel configuration.

FIG. 17 is a full section perspective view of an exemplary multi-unit modular foldable building structure in accordance with an embodiment of the disclosure.

FIG. 18 is a schematic top plan view of an exemplary multi-unit modular foldable building structure.

FIG. 19 is an enlarged detail cross-sectional view of an exemplary joining assembly between two exterior walls on adjacent room units.

FIG. 20 is a cross sectional view of an internal joining assembly between four adjacent room units.

FIG. 21A is a perspective view of an exemplary roof frame and wall frame configuration.

FIG. 21B is an exploded view of the roof-wall attachment assembly shown in FIG. 21A.

FIG. 22A is perspective view of an exemplary embodiment of a modular foldable building structure in accordance with the present invention with a truss shaped roof (gable roof).

FIG. 22B is a schematic top view of an exemplary three-unit modular foldable building structure in accordance with an embodiment of the disclosure.

### DETAILED DESCRIPTION

It is to be understood that the invention is not limited in its application to the details of construction and the arrangement of components set forth in the description and the following drawings. The use of “including” or “comprising” or “having”, for instance, shall be understood to encompass the items listed thereafter and their equivalents. The description and figures are presented to enable a person skilled in the art to make and use embodiments of the invention.

The exemplary embodiments described herein are provided for illustrative purposes only and are not limiting. Other exemplary embodiments are possible as would be understood by those skilled in the art. Adaptations and modifications that would be understood by those skilled in the art are intended to be within the meaning and plurality of the exemplary embodiments based upon the teaching and guidance presented herein. It is to be understood that the terminology used in the description is for the purpose of description and not limiting. The terminology is to be interpreted by those skilled in relevant art(s) in light of the teachings herein.

### OVERVIEW

This invention provides a modular folding building structure (10) having at least one room unit (100) assembled from two foldable modules (100′ and 100″) that are coupled together. The complete foldable building structure also has a roof. Room units can be used singly or ganged together to form multiroom structures. Each room unit has a floor that may include floor panels or floor planks supported by a floor frame.

Each room unit has four walls. The walls are connected to the floor with hinges, such that each room module has a storage position in which the walls are folded down parallel to the floor. Each module also has an erect position in which the walls are unfolded to a vertical orientation perpendicular to the floor by rotating a wall around the hinges. Connectors are provided where the walls meet to lock the walls into an erect position.

The walls may be solid walls with wall panels and appropriate openings for doors, windows, in-wall air-conditioning, medical grade ventilation systems, or other purposes. Alternatively, the walls may be largely openings. In an embodiment, open walls have an upper panel, under the roof, to provide structural support and locations for connecting members.

One or more couplers are provided to couple the two modules together to form a room unit. Such couplers may include a pin or bolt can be inserted into edge connectors to secure two modules to each other to form a room unit. A roof is installed on top of the walls. The roof may have one or more supporting members, such as a beam.

In some figures, various sides are denoted as Sides A, B, C, or D. These notations are for the convenience of pointing out certain features in the figures. In most figures, side A is the front or side facing out of the page in the drawings, and sides B, C, and D are assigned in a counterclockwise direction. These notations are internal to each figure and may change with different figures because modules or other parts can be rotated, oriented differently, or used as mirror images. Thus, there is no implication that e.g., Side A on one figure is the same side as Side A on another figure.

The folding nature of the modules of this invention allow the modules to be easily transported to a location for rapidly erecting buildings. This may be particularly useful in the event of natural disasters such as floods, hurricanes, wildfires, pandemics and the like, where mass housing or nonresidential structures such as medical clinics and hospitals may be needed on an emergency basis. The easy transportability of the inventive modules is conducive to rapid transport and assembly for such emergency use.

### Room Units

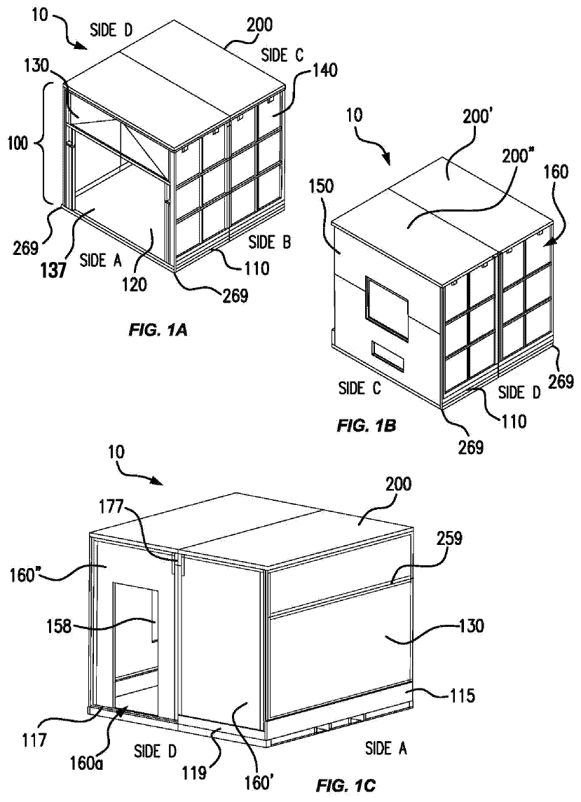

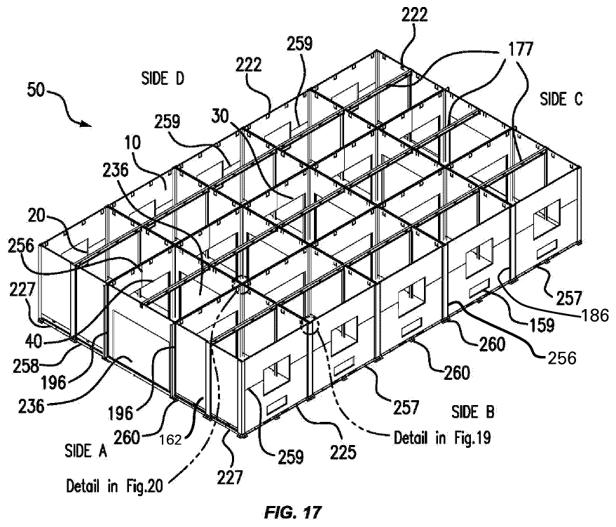

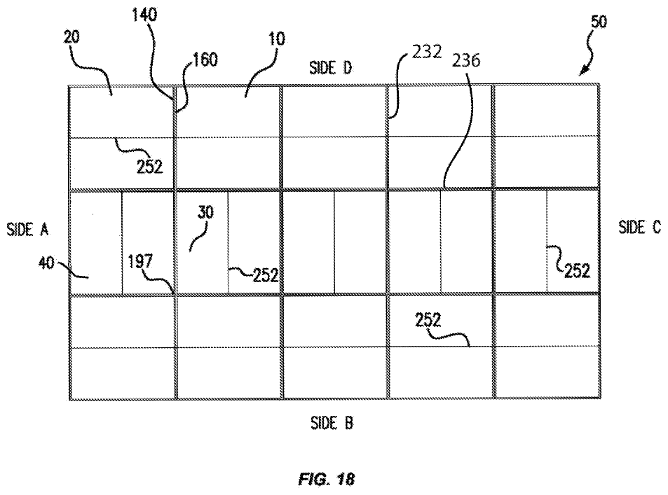

FIGS. 1A and 1B are perspective views of an exemplary modular foldable building structure (10) including a room unit 100 according to an aspect of the present invention. A “unit” as defined herein means a structure having a rectangular or square-shaped floor, at least two walls with optional windows, doors, or other openings. A modular folding building structure (10) includes a roof. In an embodiment, the roof covers the floor in 10. In some aspects, a “unit” may be synonymous with a “room.” The simplest possible configuration of this invention is shown in FIG. 1C, depicting a basic room with a floor, four walls, a door, a window, and a roof. In an embodiment, a plurality of units may be ganged together to form a larger structure with a plurality of rooms (50, FIGS. 17 and 18).

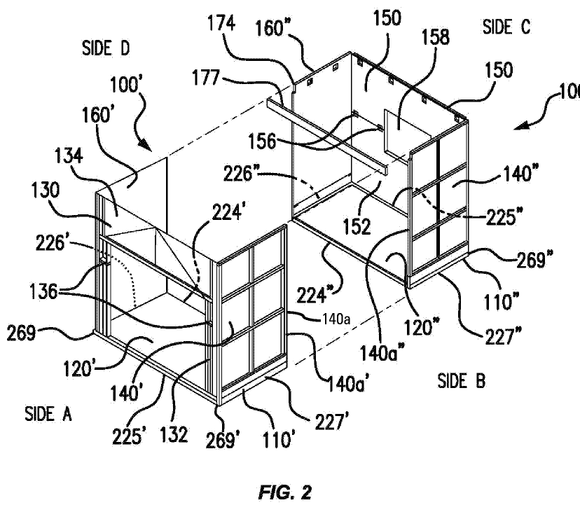

In an embodiment, a one room unit 100 includes a first foldable module (100′) and a second foldable module (100″), wherein each module has a storage position (238) and an erected position (FIG. 2), and each module has a base (110′, 110″) with a square or rectangular shape with an interior joinable edge (224′, 224″) and three exterior edges (225′, 225″, 226′, 226″, 227′, 227″), and a floor panel (120′, 120″) covering each module base, wherein each interior edge (224′, 224″) of the base is a joinable edge parallel to the exterior edge (225′, 225″) of the same module; wherein an optional bifold (multifold) wall panel (130) is hingeably attached to each exterior edge (225′, 225″), wherein the axis of the multifold wall is parallel to the floor such that the multifold wall panel, if present, folds towards the joinable edge (224′, 224″) in the storage position and unfolds in the erect position to define a right angle between the floor and front wall panel; wherein an exterior edge (226′, 226″, 227′, 227″) is a side edge of the square or rectangular shaped module wherein a side wall panel (140′, 140″, 160′, 160″) is hingeably connected to a side edge (226′, 226″, 227′, 227″), such that each side wall panel lays flat along the base in the storage position (238), and in an erected position, each side wall panel pivots upwards around the hinge to define a right angle between the floor and the wall panel; wherein the first foldable module (100′) in the erected position and the second foldable module (100″) in the erected position are configured to couple together along the joinable edge (224′, 224″) of each module to form a room unit (100) with a rectangular or square-shaped floor, and wherein a roof (200) that at least covers the floor (120) is affixed to a roof support member (177), to form a modular folding building structure.

Room unit 100 is formed from two foldable modules 100′ and 100″, connected to each other as depicted in FIG. 2. FIG. 2 is an exploded view of a room unit showing how the two modules couple together. The unit 100, as depicted in FIG. 1A, includes a unit base 110, comprising the floor and related supporting members (FIG. 5A). Unit base 110 may be covered with floor panels forming a floor 120. Room unit 100 also has a front wall 130, a rear wall 150 (shown in FIG. 1B), a proximal side wall 140 (referred herein as a “right side wall”, as it appears to the right of the front wall 130) and a distal or left side wall 160 (shown in FIG. 1B). The front wall 130, rear wall 150 and the side walls 140 and 160 are connected to the base 110 by hinge mechanisms (discussed in detail below). In an embodiment, a room unit 100 has a square or rectangular shape.

As used herein, the term “panel” means a solid sheet with a smooth surface facing an interior or exterior of the room unit or modular foldable building structure. This is distinguished from frame members which may be present in the floor, walls, and roofs of the modular foldable building structure. In some case, floors, walls, and roofs may be provided that are no more than frames. In other cases, walls or roofs may have a frame with a panel on one side of the frame only. In other cases, walls or roofs may have a frame with a panel on both sides of the frame. (FIG. 16). Panel materials may be single unitary sheet of material covering an entire section, or several large sheets, or plank materials. Suitable materials include sheet metal (typically steel or aluminum), wood, plywood, rigid plastic, composite materials such as composite wood materials or composite plastic materials.

FIG. 1B is a perspective view of unit 10 depicted in FIG. 1A, but showing its rear wall 150, its distal (left) side wall 160 and the roof panels 200′ and 200″, forming the roof.

In an embodiment, each unit 10 is formed out of two complementary modules, module 100′ and 100″, depicted in FIG. 2. For purposes of this description, a module having a front wall and an exterior edge 225′ will be referred to as a “front module” (100′) and a module with a rear wall as a “rear module” (100″). Exterior edge 225′ is on Side A, and edge 225″ is on Side C. As shown in FIG. 2, side walls 226′ and 226″ are on Side B and side walls 227′ and 227″ are on Side D.

As illustrated in FIG. 2, front module 100′ has a base 110′, a floor panel 120′ covering the base 110′, a front wall 130 and two side wall panels—proximal or right-side wall panel 140′ on Side B and distal or left side wall panel 160′ on Side D. Corresponding walls and floors are part of rear module 100″. In an embodiment, each module has a square or rectangular shape with an interior edge (224′, 224″) and three exterior edges (225′, 225″, 226′, 226″, 227′, 227″), and a floor (120) wherein each interior edge (224′, 224″) of the base is a joinable edge parallel to the exterior edge (225′, 225″) of the same module. FIG. 2 also shows corners 269′ and 269″ at the junction of 225′ and 227″, and 225″ and 227″ respectively.

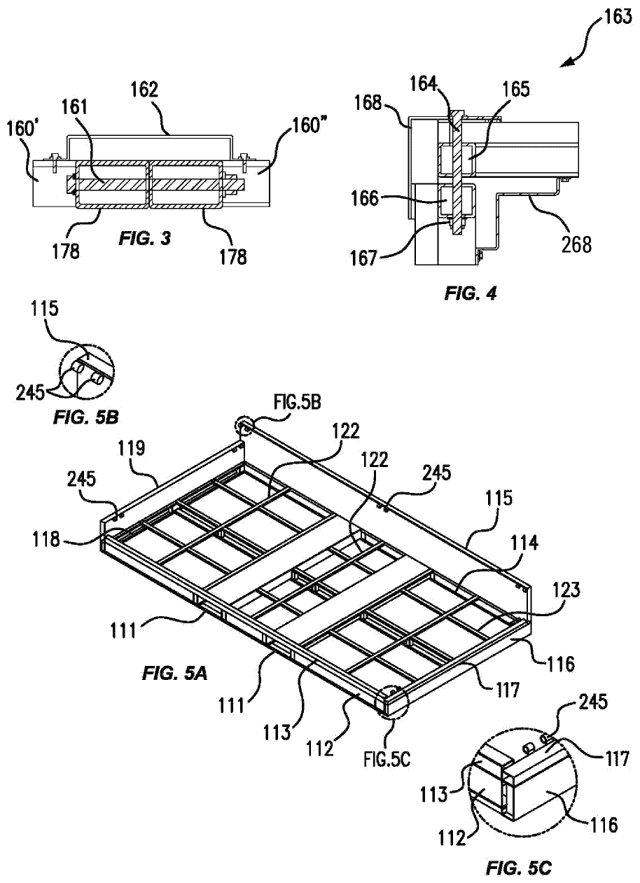

Modules 100′ and 100″ are coupled together to form a room unit, as shown in the exploded view in FIG. 2. When coupled, interior edge 224′ is joined to interior edge 224″, edge 140a′ is joined to edge 140a″, and corresponding edges on walls 160′ and 160″ are likewise coupled. In an embodiment, the coupling of 100′ and 100″ may be accomplished with a butt coupler as shown in FIG. 3. This coupler is a simple arrangement of holes drilled into wall frames 170 (FIG. 3) that a bolt 161 is inserted into. Bolt 161 may be secured, for example, by a nut. Optionally, a weather seal 162 is provided over the butt joint between the two modules. As used herein, the term “butt joint” is used for the joining to two walls or panels to form a solid surface, for example joining wall members 140′ and 140″ in the coupling of two modules together.

Various room unit configurations are possible, as illustrated in FIGS. 1A, 1B, 1C, 12A, 12B, 13A, 13B, 14A, and 14B.

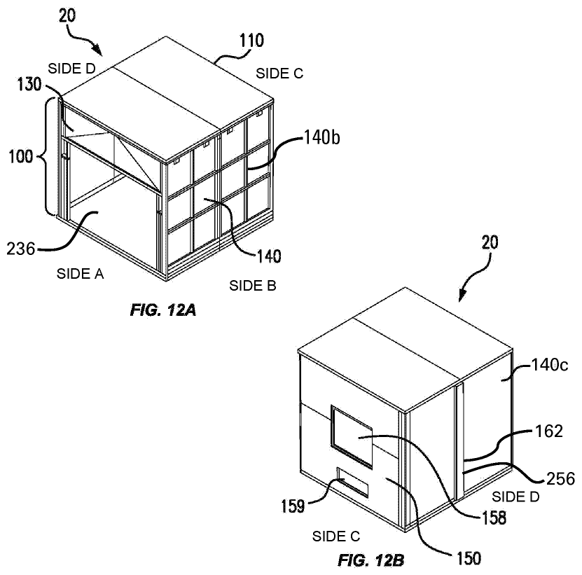

FIGS. 12A and 12B illustrate a corner unit 20. FIGS. 12A and 12B are marked with indicators for sides A-D. Side A of this embodiment has a large opening 236. Side C is a bifold wall having window openings 158 and air conditioning openings 159. Side B of this corner unit has an exposed wall framework (140b) because this wall will mate with a wall from another room unit. Side D of this embodiment is an external wall (140c) with external wall panels 184 (see wall sandwich in FIG. 16). Also shown is weather stripping 162 on side D along the butt joint 256 where two side walls from coupled modules are joined together.

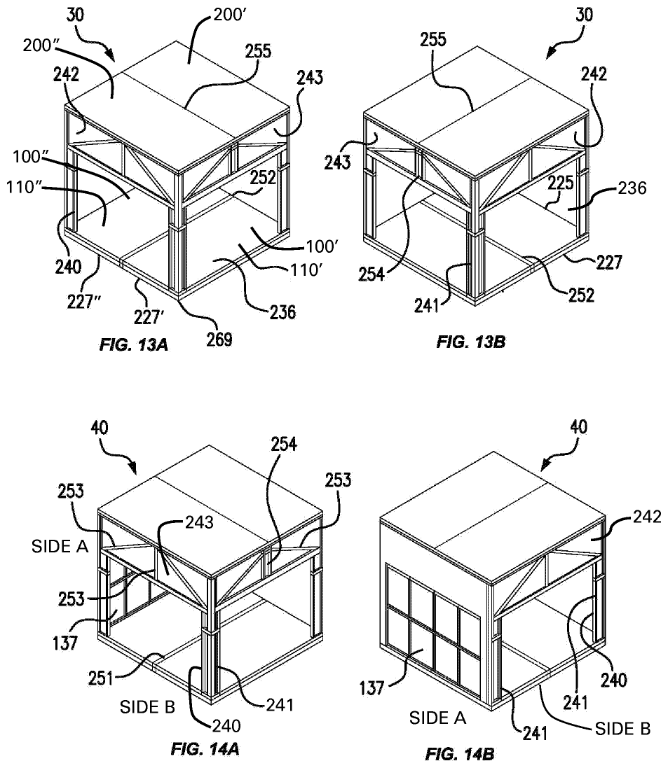

FIGS. 13A, 13B, 14A, and 14B illustrate an embodiment of a modular foldable building structure 30 and 40. Structure 30 has large openings 236 in all walls, and may be used, for example, as a corridor in a multiunit structure (FIGS. 17 and 18) or as a gazebo-like structure. The modular foldable structure 30 or 40 is constructed from two foldable modules (100′, 100″). The floors have butt joint 252 between each module, and the roof has butt joint 255 between each roof panel. Note in this embodiment, the roof panels 200′ and 200″ are oriented perpendicular to the floor panels 110′ and 110″. Also shown is a long edge upper panel (243) placed between the two upper side panels 242, where the upper side panels 242 are part of the short edge of a module 100′ or 100″ and the long edge upper panel is part of a long edge of a module 100′ or 100″. Also shown in FIGS. 13A, 13B, 14A, and 14B is the open side wall 240 having a vertical support member 241. Also shown in FIGS. 13A, 13B, 14A, and 14B are exterior corners 269 wherein each room unit short edge 227 has an open side wall 240 hingeably connected to the corner 269. In an embodiment, a panel 242 or 243 may support struts 253, and may have a double support strut 254 to support the roof supporting member.

### Module Base and Floor

FIG. 5A depicts an exemplary embodiment of a module base 110 showing the underlying frame and supporting members. The module base 110 may have a frame 112 that may support floor panels, floor planks, or other suitable flooring material. Frame 112 may have one or more transverse support members 122 and one or more longitudinal support members 123. As illustrated, frame 112 has two parallel longitudinal side members, a first longitudinal side member 113, and a second longitudinal side member 114, and two parallel end members, a first end member 116 and a second end member 118, forming a rectangle. The end side members are perpendicular to the longitudinal side members. In an embodiment, the base has a pair of forklift sleeves 111 suitable for a forklift to lift and move the module conveniently. The frame members discussed in this paragraph may be made from rectangular steel or aluminum tubes, wood, plastic, or another suitable construction material.

In an embodiment, the floor may be solid and relatively level and suitable as floor for residential or commercial (other than residential) uses. Floor panels 120′ and 120″ may comprise any conventional flooring material, such as plywood panels or wood planking, or a material such as steel, aluminum, or plastic, or another suitable construction material provided in sheets or planks. Such flooring material may be laid over the framing such as 113, 122, and 123 and secured with nails, screws, glue, or other methods, or a combination thereof. Alternatively, the floor area may be filled in with concrete or other suitable filling material to make a flat floor.

In an embodiment shown in FIG. 5A, one or more base supports 115, 117, and 119 are affixed to the edges of frame 112. As shown, the base supports are equipped with base hinge mechanisms 121 that connect to the wall panels of the module. The hinges 121 to allow the wall panels to fold over the frame in a folded position, also termed herein the “storage position” (238) to allow easy transportation and conveniently unfolding to an erected position. The base supports may be made from rectangular steel or aluminum tubes, wood, plastic, or another suitable construction material.

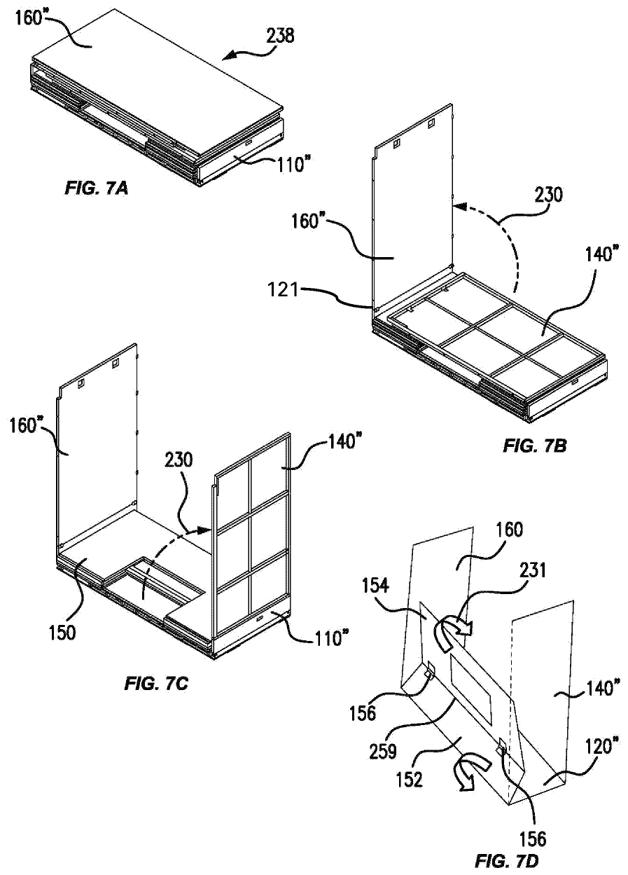

In an embodiment, the base supports 115, 117, and 119 may vary in height, to account for the thickness of the walls and to allow the walls to fold over the module base 110′ and the floor panel 120′ to form the compact flat configuration 238 as shown in FIGS. 7A, 9, and 10. That is, in the storage position, a first wall, for example 150 (FIG. 7C) is in direct contact with the floor, and a second wall, for example 140″ (FIG. 7B) lays on top of wall 150, and a third wall, for example 160″, lays on top of wall 140″ (FIG. 7A). Thus, base supports 115, 117, and 119 need to have vertical dimensions appropriate to accommodate the thickness of each wall so that the entire assembly is as compact as possible in the storage position 238. In this embodiment, the longitudinal base support 115 has greater height than the second end member base support 119, which in turn has greater height than the first end member base support 117. (FIG. 5A).

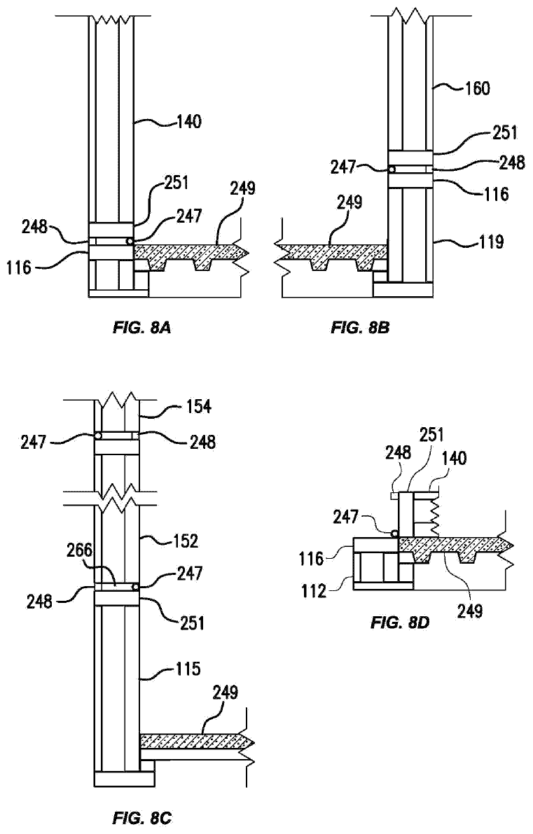

The drawings show various embodiments of the order of assembly and unfolding, all of which are in the scope of this invention. For example, in FIGS. 7B-7D, bifold rear wall 150 is the lowest layer closest to base 110, followed by wall 140″ then wall 160″. In an alternative embodiment, shown in FIGS. 5A and 8-10, wall 140 is closest to the base 110 (or floor 249 in FIG. 8), followed by wall 160, and then followed by bifold wall 150, comprising bottom panel 152 and top panel 154, on top of wall 160.

### Storage Position

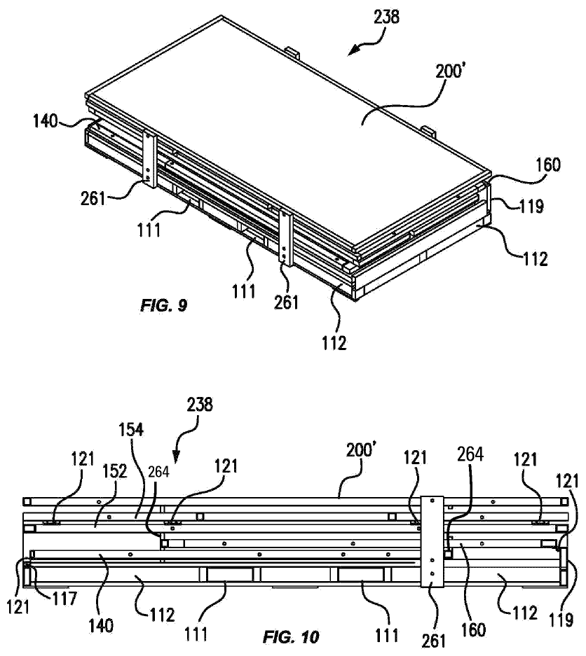

In an embodiment, each module has a storage position 238 illustrated in FIGS. 7A and 9 (isometric views). In the storage position, all walls are folded flat along the floor or base of the module (110″ in FIG. 7A, 110 in FIGS. 9 and 10). This presents a compact profile for ease of transportation and storage, with the rear wall and the side wall panels folded over the floor panel and the base 110″.

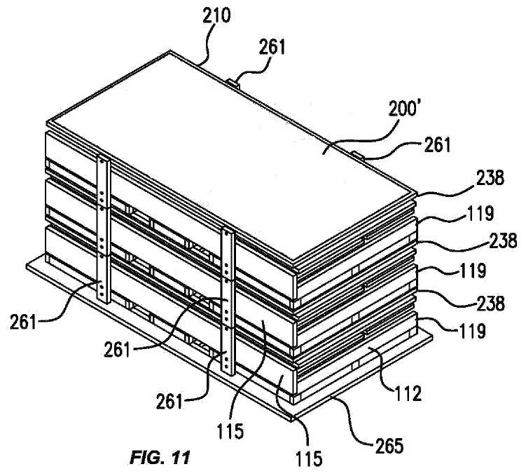

An embodiment of a storage mode is shown in the elevation view of FIG. 10, showing base 110 with wall 140 lying flat against 110 and connected to base 110 by hinges 121 anchored to base supporting member 117. On the right side of FIG. 10, base supporting member 119 is taller than 117 and wall 160 is connected to 119 with a different set of hinges 121. Walls 152 and 154 are stacked on top of wall 160, connected to supporting member 115 by hinges (121) (four hinges are shown connected 152 to 115). Also depicted in FIGS. 10 and 11 is a roof panel 200′. The roof 200′ is not connected to the other parts of folded module 238 with hinges. As shown in FIGS. 10 and 11, the roof may be attached to brackets 261, and is removed from the stack 238 prior to erection of the walls as discussed below. Rubber bumpers 264 may be used in the storage position 238 to help support walls and prevent them from scratching each other. Brackets 261 are depicted in FIGS. 9, 10, and 11 affixed to the folded module 238 with screws. The brackets keep the folded module intact, hold the roof panel in position if included, and will help prevent rattling in transit. Modules in the storage position may be stacked as shown in FIG. 11 stacked on pallet 265.

The module foldability creates the ability to fold the entire structure into compact shipping units, which allows for multiple units to be stacked on top of each other and shipped together at a lower cost. According to the present invention, all or some parts of a module remain attached together during the assembly, disassembly, and transport to ensure that nothing gets misplaced and to have them easily unloaded and moved until their final positions. In addition, having all or some parts of a module attached to each other significantly speeds up the assembly and disassembly saving time, labor and cost.

In an embodiment, the folded module 238 may be lightweight enough (depending on the material the module is made from) that it can be lifted by a group of people, for example two to six people, and manually carried into position for erection. In emergency situations, this can be an important advantage to the overall system.

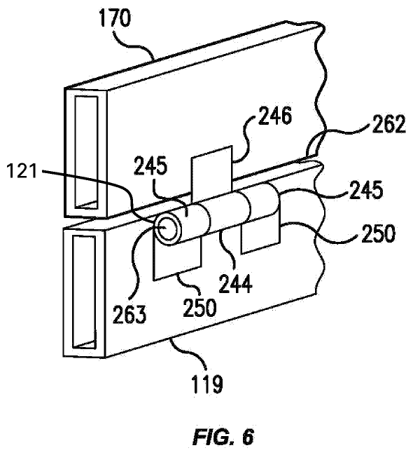

In an embodiment shown in FIGS. 6B and 6C, the side walls 140″ and 160″ are erected from the storage position to an erected position by pivoting upwards (along lines of motion 230) around hinge mechanisms 121 and along path of motion 230 to the erected position in which the walls (140″ and 160″) are perpendicular with respect to the floor 120″.

### Erection of Walls

A module may have three walls, for example front module 100′, may have walls 140′, 160′, and 130, each connected to the base 110′ by hinges. Several hinge embodiments are discussed here. This discussion is not intended to be a comprehensive discussion of hinge technology, and the specific type of hinge is not limiting as long as the range of motion required by this invention is provided.

An exemplary hinge embodiment 121 is shown in FIG. 6. This is a simple butt hinge having two outer knuckles (245, also called barrels) connected to one part (119 is illustrated) that is hingeably connected to another part (170 is illustrated). As shown in FIG. 6, hinge 121 has an inner knuckle 244 connected to 170. A pin 263 is in the center of the hinge, and the movement of the hinge rotates around pin 263. Also shown are tabs 246 on the inner knuckle, and 250 on the outer knuckles. As shown in FIG. 6, the outer knuckles are affixed to base support 119 (see FIG. 5B), and the inner knuckle is affixed to wall frame member 170. The tabs 245 and 250 may be affixed, for example by welding (in the case of steel parts), or screws, glue, or other methods of attachment, or a combination thereof. The butt joint between the hingeably connected parts 119 and 170 is joint 262.

Another hinge embodiment is illustrated in FIGS. 8A-8D showing a recessed hinge 247. In this embodiment the hinge is configured so that it is within a gap 266 in the interface between a wall such as wall 140, and a base support such as 117 (FIG. 8A). Also shown is wall end member 251 that may be part of the wall perimeter. In the erect position shown in FIGS. 8A-8C, the hinge 247 is concealed within gap 266. In an embodiment, a spacer 248 may be necessary to keep the gap in the erected wall even so that wall 140 (for example) is perfectly perpendicular to floor panels 249. The hinge 247 may also be a butt hinge with three knuckles as illustrated in FIG. 6.

FIGS. 7A-7D show a progression of the unfolding of a module 100′ or 100″. From the storage position 238 in FIG. 7A, first wall 160″ is unfolded (FIG. 7B) to an erect position along line of motion 230. Second wall 140″ is then unfolded as shown in FIG. 7C. Bifold wall 150 is then unfolded along directions of motion 231 as shown in FIG. 7D.

An embodiment of the front and rear walls is illustrated in FIG. 7D, showing rear wall 150, but the same mechanism may apply also to front panel 130. In an embodiment, walls 130 and 150 are both bifold-style walls (also termed multifold or accordion walls), with a horizontal union 259 between a top panel 154 and bottom panel 152. A set of hinges 156 links panels 152 and 154. In the storage position illustrated in FIG. 7A, rear wall 150 is folded and lays flat on base 110″. After side walls 140″ and 160″ are unfolded and secured in position, rear wall 150 is unfolded bifold-style around hinges 156. As shown in FIG. 7D, when unfolded (arrows showing movement 231), panel 152 pivots away from edge 224″, and top panel 154 pivots towards edge 224″.

After all walls are assembled in an erect position, the side walls may be secured to the front or rear walls. In an embodiment, this is accomplished as shown in FIG. 4, depicting a corner wall joint 163 of two perpendicular wall panels forming an external corner of a unit according to an embodiment of the present invention. Internal corners of a unit may be joined in substantially similar manner. The corner wall panels are attached to each other with one or more joining elements. FIG. 4 shows an exemplary embodiment of a joining mechanism comprising a threaded bolts 164 inserted across the corner vertical post 165 of a wall perpendicular to the direction of insertion and the vertical post 166 of the longitudinal wall and fastened with a nut 167. An external corner guard 168 and internal L-shaped corner profile 169 can be installed on the external and respectively internal side of the joint.

Another wall embodiment, as illustrated in FIGS. 1A, 1B and 2 a foldable (front) module 100′ is shown with an open face wall 236. This type of wall may be important, for example, in internal room units ganged together as shown in FIGS. 17 and 18, where hallways or open spaces are desired. In the embodiment illustrated in FIGS. 1 and 2, the bottom half (132) of wall 130 with an open face is largely a frame with hinges on the bottom connecting each side of the frame to the floor, and central front hinges 136. A portion of the top panel 134 continues the frame of bottom panel 132, and in an embodiment, a portion of top panel 134 is a solid panel 243.

Any of the wall panels can also have one or more openings for a door, air conditioner, windows or other purpose. An exemplary opening 158 is depicted in rear wall 150 in FIGS. 1 and 2. Opening 158 may be for a window, air conditioning unit, or other purpose requiring an opening in a wall. Other openings can be doors (e.g., 160a in FIG. 1C). In an embodiment, a door is provided in at least one room unit.

### Wall Construction

In an embodiment, a multifold or bifold front wall 130 or rear wall 150 may be formed from two horizontal panels—a bottom panel (132, 152) and a top panel (134, 154). The bottom panels may be connected to the base 110′ or 110″ with hinge mechanisms 121. The bottom panels 132, 152 and the top panels 134, 154 may be connected to each other by one or more hinge mechanisms 136, 156. The seam between a bottom panel and top panel is 259 (FIGS. 2 and

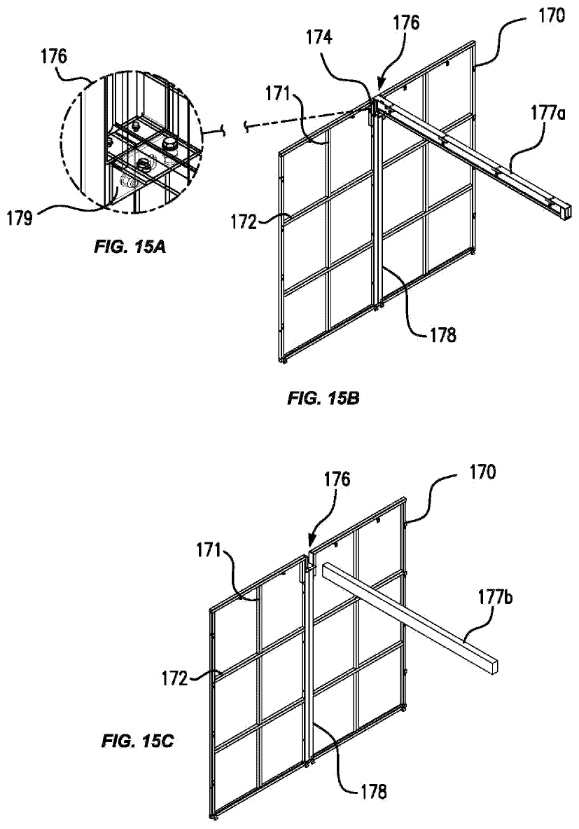

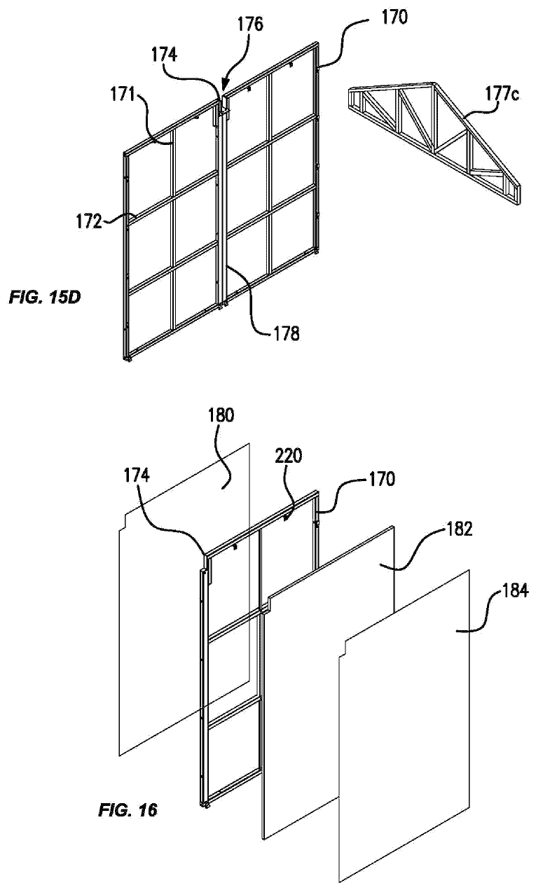

An embodiment of the construction of a side wall such as 160 or 140 is shown in FIG. 16. This embodiment shows a sandwich construction with an inner frame 170 having vertical edge members 178, and an interior longitudinal cross member 171 and at least one transverse cross member 172 (171 and 172 are shown in FIG. 15D). The vertical frame member 178 is on the edge coupled to the other module. In an embodiment, the aforementioned frame members may be fabricated from rectangular tubular steel, but other materials may be used, including wood such as 2×4 boards or a rigid plastic or another suitable construction material for rigid lightweight construction.

An interior panel 180 may be affixed to the frame. An exterior panel 184 may be affixed to the frame 170. The manner of affixing is dependent on the materials used. If steel, either panel may be weldable to the frame. Alternatively, screws, nails, glue, or other method of attachment may be used. In an optional embodiment, an insulation layer 182 may be interposed between the frame and exterior panel 184.

In an embodiment, panels 180 and 184 may be steel sheet metal with a thickness varying from 18 gauge (1.2 mm thick) to 30 gauge (0.3 mm thick) or other thickness. In a specific embodiment, the interior panel 180 is 26-gauge steel sheet metal (about 0.5 mm thick), and exterior panel 184 is 22 gauge steel sheet metal (about 0.8 mm thick). Either panel may be painted or powder coated on the side facing away from the wall frame. The optional insulation layer 182 may be a foam insulation sheet, such as extruded polystyrene, polyisocyanurate, polyurethane sheet insulation or another suitable insulating material. These materials are typically available in from 0.75 in (19 mm) to 4 in (102 mm) thickness, in 4′×8′ sheets (American sizes). In an embodiment, sheet polyurethane with a thickness of 30 mm (1.2 in) may be used. The thickness of the insulation may vary with the weather in a particular location. A location with cold winters may require a thicker layer of insulation. Interior walls in multiunit assemblies will not need an exterior panel 184 or an insulation layer at all. In an embodiment, the folded modules 238 may not include the insulation 182 and exterior panel 184 because the required insulation is too thick to be conveniently packaged in a storable module 238. In such an embodiment, the walls may include interior panel 174 and frame 170, and insulation 182 and exterior panel 184 is installed after the room is erected. In an embodiment, the insulation has fire resistant properties, or the insulation can be covered by a fire-resistant layer. Acoustic insulation can also be added to the wall panels to help decrease noise transference.

Many different types of materials may be used in this invention. For example, panels 174 and 184 may be made from steel sheet metal or other materials such as aluminum sheet metal, other types of sheet metal, plastic, drywall (for interior panels) wood paneling, or other suitable construction materials. Walls and flooring made entirely of rigid plastic may have a cost advantage, being less expensive than steel, and a weight advantage, being lighter than steel or wood. A lower weight module is presumably less expensive to ship since weight may be a factor in shipping costs. Also, if sufficiently light weight, a module may be picked up by a team of two to six people and carried a short distance instead of a forklift.

Anchoring a moveable structure of this invention, even if made from steel, may be important to prevent high winds from moving the building. Anchor tabs 260 are shown in exterior edges 257 in FIG. 17, for firmly attaching the room units to the ground, e.g., a concrete slab.

In an alternative embodiment extended wall panels can be added to increase the height of the structure. An extended height wall may only have a small extension, such as an inch (2.5 cm), to ensure that the roof has a slope for drainage. In another embodiment, an extension may be larger. An extension may be desired for functional or architectural purposes.

### Coupling of Modules

With the two modules 100′ and 100″ thus described and assembled in the erected position as shown in FIG. 2, the two modules are now coupled together to form a room unit 100. In an embodiment, joinable each module has a joinable edge 224 on the base that is coupled, and each module has joinable edges e.g., 140a on the side wall panels that are coupled, for example edge 140a′ of wall panel 140′ joining to edge 140a″ (FIG. 2).

It should be apparent that the two modules should be positioned so that the floor of each module is level. The requisite position may include ground preparation or mounting the modules on blocks or a foundation that provides appropriate support for the finished structure. In an embodiment, the units are installed on a concrete slab or a paved area such as a parking lot. In a multiroom assembly such as in FIG. 17, the entire structure may be installed at the same level.

In an embodiment, coupling of the two modules may be accomplished with bolts through frame members 178 as shown in FIG. 3 to form butt joints 256 between side walls in each module, for example edge 140a′ of wall panel 140′ joining to edge 140a″ (FIG. 2). In this embodiment, a plurality of holes may be precisely drilled in each frame member 178 (see also FIG. 3) that bolts 161 can be inserted into. In an embodiment a nut is used with the bolt 161 to secure it. A minimum of two couplings is needed along each wall to be joined, but more couplings, for example three to six, may be used. Additional couplings may be provided along the floor edges 224′ and 224″ (FIG. 2).

When joined together the module base 110′ of the front module 100′ and the module base 110″ of the rear module 100″ form the unit base 110, and respectively the floor panels 120′ and 120″ are joined together to form the unit floor 120. This forms room unit 100, having a floor and four walls. Note that in some embodiments, the walls may be open for decorative or architectural purposes (for example, for forming hallways or open spaces).

### Roof Embodiments

With the room unit 100 thus described, a roof 200 is necessary since this invention provides buildings and rooms providing shelter from the elements. In an embodiment, a roof is supported by a supporting member 177 depicted in FIGS. 15A-15D which may have several different embodiments.

To support a roof, some wall panel frames may have a notch 174 depicted in FIGS. 15B and 16. When two adjacent wall panels are attached together, their notches 174 form a pocket 176 (FIG. 15C) to receive a roof supporting member such as a steel I-beam 177a as shown in FIG. 15A. In different embodiments, as shown in FIG. 15C, a rectangular steel tube 177b can be used. A truss embodiment (177c) is shown in FIG. 15D, which would be used to support a pitched roof (FIG. 23A). Other supporting members are possible also, including a solid beam, or a C-beam. For example, a 2×4 or 4×4 wood board may be used as a support member. In an embodiment, the I-beam 177a, shown in FIG. 15A, is nested into a pocket 176 formed integrally between notches 174 from two adjacent sidewall panels, and is supported by the opposite vertical wall panels (not shown) in the same manner. An embodiment for securing a roof supporting beam is detailed in blow-up view FIG. 15B, showing brackets 179 bolted to the bottom bar of 177a. The roof supports such as 177a need not run parallel to the butt joint 252 between module floors. A roof support such as 177a can be oriented perpendicular to butt joint 252 as shown in FIG. 13A.

With a roof supporting member in place, roof panels can be affixed to the walls and supporting to form completed room units such as 10, 20, 30, or 40 (FIG. 1, 12, 13, or 14).

In an embodiment, roof panels may have a sandwich construction analogous to the wall construction shown in FIG. 16, with frame 210 (FIG. 21A) sandwiched between an interior panel and an exterior panel with an optional insulation layer.

In an embodiment, depicted in FIG. 21A, a flat roof panel includes a frame 210 stiffened by one or more cross members, which can be in longitudinal direction (longitudinal wall member 214) and/or transverse direction (transverse wall member 212) to the perimeter frame or a plurality of support ribs and can be further stiffened by corner gussets 216. In a preferred embodiment the frame 210 and the support ribs 212, 214 are made of steel. Other materials suitable for the frame and the support ribs are steel, plastic, aluminum, composite material or wood or any other or other suitable construction materials.

In an embodiment, the roof frame 210 covers one module. The roof may be supported by the vertical wall panels for example 140′, 160′ and of the side walls 140 and 160, respectively, and by the I-beam 177a which spans horizontally between the opposite side walls 140, 160 of the unit. Additionally, the front and/or rear walls may further support the roof and stiffen the structure so it can withstand lateral forces.

A roof frame 210 is depicted in FIG. 21A affixed to a wall frame 170. This may be accomplished, for example, with brackets 218 and 220 joined with a bolt 222 as shown in blow up FIG. 21B. For example, U-shaped tabs 218 attached to the roof frame 210 may be bolted to a wall piece, preferably a hinged slotted piece 220 attached to the wall panel perimeter frame 170 by a roof-wall nut-bolt connection 222 to secure the roof frame 210 to the wall frame 170. This type of connection simplifies the roof installation, so it can be performed from inside the unit and it only requires a lock nut wrench or a screw gun and allows easy adjustment during assembly. Three of the sides of the roof frame are attached to the walls of the unit with the remaining side of the roof frame 210 aligned with the supporting beam such as 177a and secured to the top flange of the I-beam 177a.

In an embodiment, the roof may require either a pitch or a slope so rainwater drains off. This can be accomplished by ensuring that one wall is slightly higher so that a flat roof has a slight slope. Alternatively, a truss roof support such as 177c may be used to provide a pitched roof.

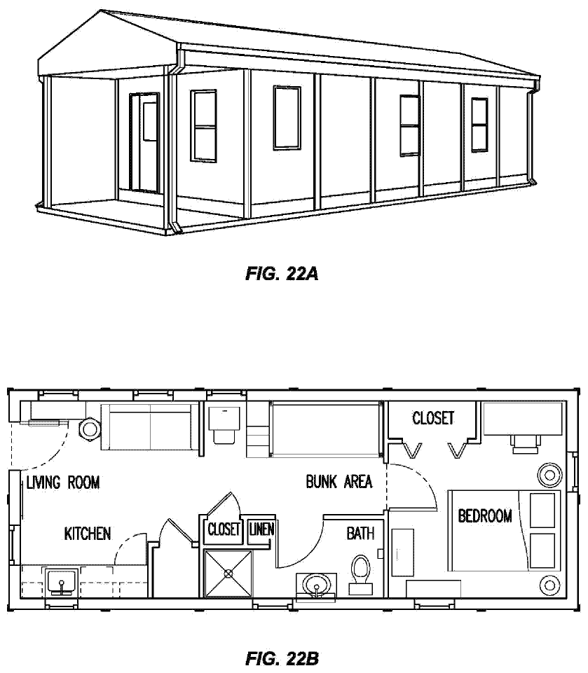

In an alternative embodiment depicted in FIG. 22A, a gable roof is mounted on a truss structure which is attached do the wall panels. This embodiment would require a minimum of two truss supports (177c).

In alternative embodiments, the roof might have other shapes, including hip, shed (mono slope) or other shapes.

### Room Unit Configurations

The modular structures disclosed in this invention are scalable in that the already assembled units may be added together to form larger structures with multiple enclosed spaces. For example, the unit structure can be assembled as two, three four or more compartments in a single row or in multiple rows or as branched structures. The units are also stackable to form a multi-storied structure with stairwells and elevators. Various exemplary unit configurations are formed by matching different modules as shown for example in FIGS. 1, 13, 14 and 22. The modular aspect of the invention contributes to its versatility and cost efficiency.

In an embodiment, room units such as 10 may form a cube with dimensions of 12′ length (L)×12′ width (W)×12′ high (H) (in American dimensions). In metric dimensions, this is 3658 mm L×3658 mm W×3658 H. The unit dimensions, however, can vary depending on the needs. For example, standard American plywood dimensions are 4′ W×8′ L, and room units could be made to this dimension, to form room units 8′ L×8′ W×8′ H. From an architectural standpoint, rooms 12′ W are comfortable as living and working spaces. Moreover, the final room unit need not have a square profile. It could also be rectangular.

In different embodiments the modules' dimensions can be varied in size and shape to meet the client's needs and form rectangularly or square shaped spaces of different dimensions and/or habitable spaces having different shapes.

For example, FIGS. 1A and 1B depict two different isometric views of a representative room unit 10 having an open front (236) in wall 130, a rear bifold wall 150, and side walls 160′, 160″, 140′ and 140″. An alternative simple embodiment is shown in FIG. 1C, showing a single room unit with four walls and a roof. A door opening 137 is shown on side A, which is a minimum requirement in an architectural enclosure, even if used for nothing but storage. A window 158 is also shown on side B.

Modules can be joined together in an innovative variety of ways to create structures of various sizes, shapes and for different uses. For example, a simple home is shown formed from three coupled units in FIGS. 22A (isometric view) and 22B (floor plan). In the embodiment of FIG. 22A, roof trusses such as 177c (FIG. 15D) would be used. Several of these trusses may be required to properly support the roof.

More complex ganged structures are shown in FIGS. 17 and 18. These may be used for multifamily housing, hospitals, retail spaces, or offices. Rooms (units) can be easily added, modified or removed depending on the needs. For instance, in a hospital environment, rooms for various uses can be added to respond to rapid surge of patients and can be subsequently disassembled to be relocated or stored in a folded compact manner for future use.

FIG. 17 is an isometric view showing walls of a structure three room units wide and five room units long. This could be used for example for medical uses or a hospital. A large opening 236 on Side A provides a wide entry to the structure. Opening 236 may further be equipped with a wide door 137 (FIG. 14B). The central set of units all have openings 236 the entire length of the structure to form a central corridor spanning side A to side C. Large openings 236 are also shown on the side walls (side B and side D walls) of the central corridor, but some of these side walls may be solid partitions or may only have a standard width door (32″ or 36″) (American dimensions). The outer room units along side B all have windows 158 on the exterior wall, shown as bifold walls with a crease 259. Also depicted in FIG. 17 are air conditioning unit openings 159 in each room unit on side B. All butt joints between exterior room units in FIG. 17 are shown with weather seals 162. Also shown in FIG. 17 are tabs 260 to anchor the structure to the ground, for example a concrete slab.

Various room unit configurations are pointed out in FIGS. 17 and 18, such as room units 10 having three interior walls and an exterior wall, corner units 20 also shown in FIGS. 12A and 12B, room units 30 forming interior hallways with two open walls (FIGS. 13A and 13B) and mated to other units on all sides, and room units 40 (FIGS. 14A and 14B) having four open walls where one opening is on an exterior wall. As shown in FIG. 18, wall 140 of a room unit 20 (in the Side A/D corner of FIG. 18) abuts wall 160 of a room unit 10, abutting the exterior of Side D. Note that there is no need for exterior panels 184 or insulation 182 in walls 140 or 160 where the walls are in contact internally like this. In an embodiment, one or more room sides of a room unit 100 comprising short edges (232) can be joined to form a plurality of interconnected foldable units. In an embodiment, one or more room sides of a room unit 100 comprising long edges (234) can be joined to form a plurality of interconnected foldable units. In an embodiment, edges 232 and 234 can be joined. Any combination of combining edges 232 and 234 are possible.

Room unit 10 is illustrated in FIGS. 1A and 1B, showing a large opening 236 on side A and window openings 158 and air conditioning openings 159 on side C. Note that in FIGS. 1A and 1B, the wall framework is shown exposed because sides B and D mate with other room units so there is no need for an exterior panel for sides B and D in room unit 10 where the wall is an interior wall in a multiunit structure.

FIGS. 13A and 13B show a corridor (or hallway) room unit 30 having open walls on all four sides.

FIGS. 14A and 14B show an end corridor unit 40 having open walls on all four sides, but also having a wide door 137.

In an embodiment illustrated in FIG. 18, the orientation of the modules joined to make room units is alternated, so the joints 252 run from side A to side C along the side D line of modules, and from side B to side D on the central line of modules. This alternating orientation may increase the strength and stiffness of the entire structure.

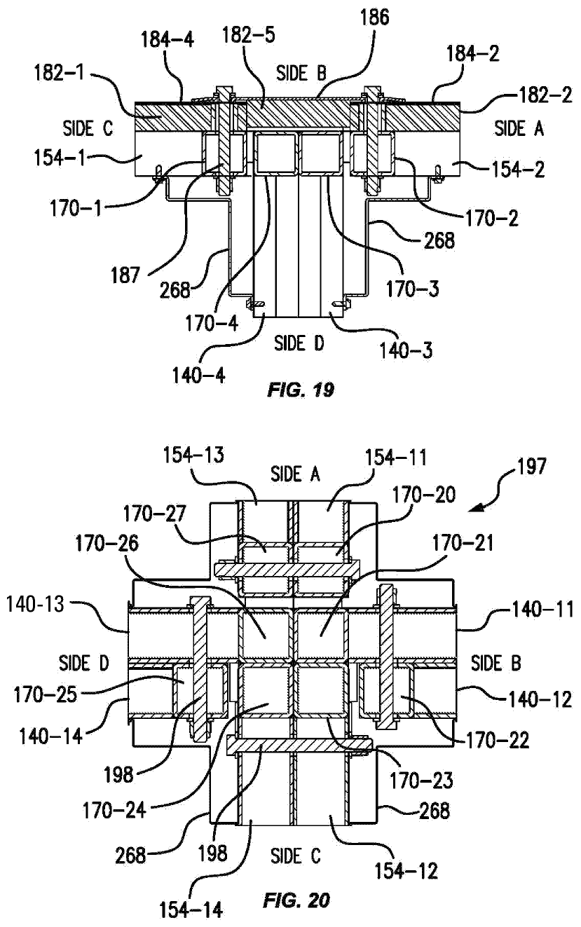

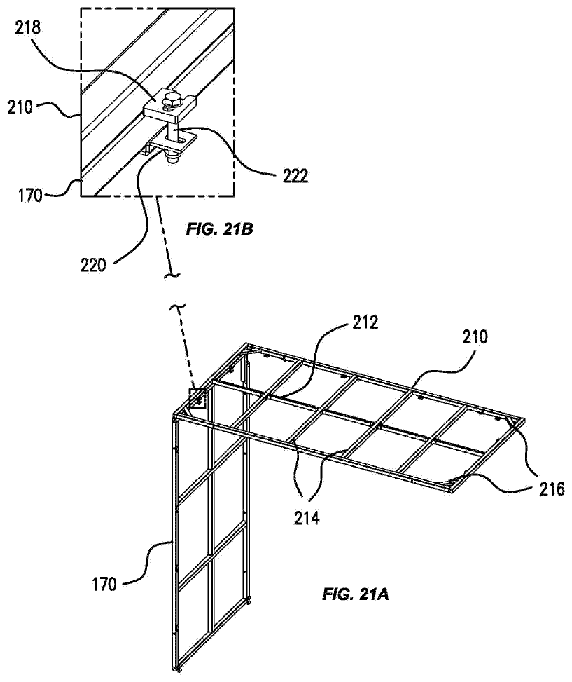

In a multiunit structure such as depicted in FIGS. 17 and 18, room unit walls are joined together. Embodiments showing mechanical details of such joined parts is shown in FIGS. 19 and 20.

FIG. 19 shows an embodiment of joinery of adjacent exterior panels, forming a seam covered by a joining part 186, which is secured by a bolt-nut connection 187 to the adjacent walls. Part 186 performs a similar function to weather seal 162, but 186 is used between two room units, not in the butt joint between two modules within a single room unit. FIG. 19 is a cross-sectional blow up of a joint pointed out in FIG. 17. Outer wall 154-1 is joined to outer wall 154-2 here. Wall 154-1 forms a corner of a room unit with wall 140-4, and wall 154-2 forms a corner with wall 140-3. Wall 154-1 includes rectangular tube 170-1, wall 154-2 includes rectangular tube 170-2, wall 140-3 includes tube 170-3, and wall 140-4 includes tube 170-4. Also shown is insulation layer 182-1 and exterior sheet 184-1 affixed to wall 154-1. Likewise, insulation layer 182-2 and exterior sheet 184-2 is affixed to wall 154-2. An insulation strip 182-5 fills the gap in insulation between 182-1 and 182-2. A sheet metal strip 186 spans the gap between 154-1 and 154-2 with sufficient overlap for bolts 187. Bolts 187 (two are shown) secure the entire sandwich together as shown. The bolts 187 penetrate tubes 170-1 and 170-2. Optionally, corner cover 268 covers the corner and bolts 187. In an embodiment, at least two sets of bolts 187 as depicted in FIG. 19 are used for each exterior butt joint between adjacent units, but additional connections using bolts 187 may be employed.

The purpose of the joint design in FIG. 19 is also to seal and waterproof the seam between the insulation panels 182-1 and 182-2. In an embodiment, the joining part 186 will be installed at the external walls between two units, for instance, as depicted in FIG. 17 where one unit 10 is attached to another unit 10, or a unit 10 is attached to a corner unit 20 or a corner unit 20 is attached to a unit 30.

FIG. 20 depicts an embodiment of a cross section of an interior joint 197 joining four units. A typical installation with this joint is pointed out in FIG. 17. In FIG. 20, wall 154-11 is part of a module with wall 140-11; wall 154-12 is part of a module with wall 140-12; wall 154-14 is part of a module with wall 140-14; and wall 154-13 is part of a module with wall 140-13. Each wall (eight) has a rectangular tube in the frame marked 170-20 through 170-27. A series of four bolts 198 links each corner together. For example, one bolt 198 joins walls 154-11 to 154-13, which are part of adjacent room units. Also shown are optional corner covers 268 that conceal the bolts.

In an embodiment, at least two sets of bolts 198 are used for each four-way corner, but additional sets may be used.

### Method of Erection

The invention provides a method for erecting the foldable modules, assembling the erected modules into room units, and optionally linking a plurality of room units together.

In an embodiment of the method, a user transports folded modules 238, optionally stacked as depicted in FIG. 11, to a desired location, where modules can be picked up for example by a forklift using forklift sleeves 111 in each module and moved to the desired position where the room unit will be assembled. If brackets 261 are present, they are removed. If a roof panel 200′ is present, it is removed and set aside. The assembly of the first module body may proceed according to the exemplary method depicted in FIGS. 7A-7D by unfolding each wall panel, by pivoting it relative to the base from a folded position to an erected position perpendicular to the base 110. Note that the order of erection of wall panels may vary. For example, as depicted in FIG. 7A-D, the side walls are erected first, followed by the bifold wall 150. In the embodiment shown in FIGS. 9 and 10, the bifold wall 150 is erected first, followed by both side walls. Both arrangements are within the scope of this invention. After the walls are erected, they may be secured with the joinery depicted in FIG. 4, which will lock the walls into position. The same steps are followed for the unfolding of the complimentary module. The two complimentary modules are then attached and secured together by attachment joinery for example as shown in FIG. 3.

In an embodiment, the user then installs a roof support beam, such as an I-beam 177a (FIG. 15A), in the beam pockets formed in two opposite walls of the unit. Finally, the user installs the roof, which can be flat, gable, hip, shed or another shape. In an embodiment, the roof panel was part of shipped module 238 and was set aside earlier is used. Alternatively, separate roof panels may be shipped separately.

These steps are repeated for subsequent units for ganged assemblies, which can then be assembled together with joining elements as depicted in FIGS. 19 and 20 to form larger multi-unit structural assemblies as shown in FIGS. 17 and 18. With multiunit assemblies it may be advantageous to assemble the walls and roof support structures for the entire assembly rather than install the roof on each individual room unit as the walls are completed.

Larger open spaces within the modular structure can be added by assembling units from two complimentary modules having at least a floor base, a floor panel covering the base, a roof and one or more elements supporting the roof. To assemble such multi-unit structures, the user will transport the base, covered with the base panel, to the desired location and erect the roof supporting elements of each module. Thereafter, the user will attach the body of each module to form a unit body. Additional unit bodies are assembled and joined together to form the body of the multi-unit structure. The user, then installs the horizontal beams in the beam pockets. Finally, the user installs the roof panels over the supporting elements and the beams to form a multi-unit structure. Depending on the requested specifications, insulation panels and a waterproof membrane can be installed over the roof of the multi-unit structure. Depending on the needs of the user, complimentary modules can be mixed and matched allowing for spaces of various shapes, dimensions and uses.

The base, walls, and roof of the room units may further be equipped with electrical and plumbing fixtures, such as electrical wires, electric fixtures, pipes, toilets and sinks. Parts such as wires and pipes (fresh water or sewer water) may be installed during manufacture of the units or may be installed on site. Bulky fixtures such as sinks, toilets, and light fixtures may be installed on site.

### DRAWING LEGEND

| Parts | |
|---|---|
| Numbers | Description |
| 10 | Modular foldable building structure. This includes a roof. |
| 20 | Corner unit of Modular foldable building structure |
| 20′ | Front module of the corner unit |
| 20″ | Rear module of the corner wall |
| 30 | Room unit with open walls (Hallway internal unit) |
| 40 | Hallway external unit |
| 50 | Multiunit assembly |
| 100 | Room unit-without roof. A room unit is a modular folding |
| | building structure without the roof. |
| 100′ | Front (first) module body |
| 100″ | Rear (second) module body |
| 110 | Unit base |
| 110′ | module base of module 100′ |
| 110″ | module base of module 100″ |
| 111 | Forklift pocket (sleeve) |
| 112 | Module base peripheral frame |
| 113 | First longitudinal base frame side member |
| 114 | Second longitudinal base frame side member |
| 115 | Base frame member base support-greatest height |
| 116 | Base frame first end member |
| 117 | Base frame member base support-lowest height |
| 118 | Base frame second end member |
| 119 | Base frame member base support-intermediate height |
| 120 | Unit floor |
| 120′ | Front module floor panel |
| 120″ | Rear module floor panel |
| 121 | Hinge mechanism |
| 122 | Base transverse support members |
| 123 | Base longitudinal support member |
| 130 | Bifold or multifold wall, wall panel (side A) |
| 132 | Front wall bottom panel (mostly open) |
| 134 | Front wall top panel |
| 136 | Front wall hinge mechanism |
| 137 | Front wall wide door |
| 140 | Right/proximal side wall |
| 140′ | Front module right side wall panel (FIG. 2 side B) |
| 140″ | Rear module right side wall panel |
| 140b | Side wall exposed framework for mating with another room |
| | unit. |
| 140c | Side wall with exterior panel |
| 140a | Joinable edge of side wall panel |
| 140a′ | Edge of side wall that couples to the other module |
| 140a″ | Edge of side wall that couples to the other module |
| 140-3 | Side wall 140 in an exterior joint (FIG. 19) |
| 140-4 | Side wall 140 in an exterior joint (FIG. 19) |
| 140-11 | Side wall 140 a joint with four interior units (FIG. 20) |
| 140-12 | Side wall 140 a joint with four interior units (FIG. 20) |
| 140-13 | Side wall 140 a joint with four interior units (FIG. 20) |
| 140-14 | Side wall 140 a joint with four interior units (FIG. 20) |
| 150 | Bifold or multifold wall on long side of module |
| 152 | Bifold or multifold wall bottom panel |
| 154 | Bifold or multifold wall top panel |
| 154-1 | Panel 154 in a joint with adjacent exterior panels (FIG. 19) |
| 154-2 | Panel 154 in a joint with adjacent exterior panels (FIG. 19) |
| 154-11 | Panel 154 in a joint with four interior units (FIG. 20) |
| 154-12 | Panel 154 in a joint with four interior units (FIG. 20) |
| 154-13 | Panel 154 in a joint with four interior units (FIG. 20) |
| 154-14 | Panel 154 in a joint with four interior units (FIG. 20) |
| 156 | Bifold or multifold wall hinge mechanism (mid-wall) |
| 158 | Window opening |
| 159 | Wall air conditioning opening |
| 160 | Left/distal side wall (side D) |
| 160′ | Front module left side wall panel |
| 160″ | Rear module left side wall panel |
| 160a | Door in side wall |
| 161 | Bolt-nut butt coupler |
| 162 | Weather seal over butt joint between modules |
| 163 | Corner wall joint |
| 164 | Threaded bolt |
| 165 | Vertical post of perpendicular wall |
| 166 | Vertical post of longitudinal wall |
| 167 | Nut |
| 168 | External corner guard |
| 169 | L-shaped corner profile |
| 170 | Wall frame |
| 170-1 | Wall frame rectangular tube member in an exterior joint |
| | (FIG. 19) |
| 170-2 | Wall frame rectangular tube member in an exterior joint |
| | (FIG. 19) |
| 170-3 | Wall frame rectangular tube member in an exterior joint |
| | (FIG. 19) |
| 170-4 | Wall frame rectangular tube member in an exterior joint |
| | (FIG. 19) |
| 171 | Wall frame longitudinal cross member |
| 172 | Wall frame transverse member |
| 174 | Notch in wall panel for roof supporting member |
| 176 | Beam pocket |
| 177 | Central roof supporting member |
| 177a | Horizontal I-Beam |
| 177b | Tube-rectangular steel |
| 177c | Truss |
| 178 | Wall vertical frame members-outer edges |
| 179 | Seated connection bracket |
| 180 | Interior wall finish panels |
| 182 | Wall insulation |
| 182-1 | Wall insulation in an exterior joint (FIG. 19) |
| 182-2 | Wall insulation in an exterior joint (FIG. 19) |
| 182-5 | insulation strip in an exterior joint (FIG. 19) |
| 184 | Exterior wall finish panels |
| 184-1 | Exterior panel in an exterior joint (FIG. 19) |
| 184-2 | Exterior panel in an exterior joint (FIG. 19) |
| 186 | Joining part-exterior wall of adjacent room units |
| 187 | Bolt nut connection |
| 197 | Interior units joint |
| 198 | Interior joint threaded bolts |
| 200 | Unit roof |
| 200′ | Front module roof panel |
| 200″ | Rear module roof panel |
| 210 | Roof frame |
| 212 | Roof frame transverse member |
| 214 | Roof frame longitudinal member |
| 216 | Corner gusset in roof |
| 218 | U-shaped tab-wall roof connection |
| 220 | Connector on wall for roof coupling |
| 222 | Wall-roof nut-bolt connection |
| 224 | Joinable edge of module base |
| 224′ | Joinable edge of module base 100′ |
| 224″ | Joinable edge of module base 100″ |
| 225 | Exterior long edge of room unit base |
| 225′ | Exterior long edge of first module base (100′) |
| 225″ | Exterior long edge of first module base (100″) |
| 226 | First short edge of module base |
| 226′ | First short edge of first module base (Side B) |
| 226″ | First short edge of second module base (Side B) |
| 227 | Second short edge of module base |
| 227′ | Second short edge of first module base 110′ |
| 227″ | Second short edge of first module base 110″ |
| 230 | Unfolding direction of motion in side panels from storage to |
| | erect position (FIGS. 6A, 6B) |
| 231 | Unfolding direction of motion in front/rear panels from |
| | storage to erect position (FIG. 6D) |
| 232 | Joined short edges joinable to a plurality structure of room |
| | units |
| 234 | Joinable long edges for a plurality structure of room units |
| 236 | Large opening in wall |
| 238 | Front or rear module in storage position |
| 240 | Side wall with large opening |
| 241 | Vertical support of open side wall having 236 |
| 242 | Upper side panel of open side wall having 236 |
| 243 | Upper panel of open side wall on open long edge |
| 244 | Central knuckle (hinge barrel) of hinge 121 |
| 245 | Outer knuckle (hinge barrel) of hinge 121 |
| 246 | Tab on central knuckle of hinge 121 |
| 247 | Recessed hinge |
| 248 | Recessed hinge spacer |
| 249 | Floor panel |
| 250 | Tab on outer knuckles of 121 |
| 251 | Wall end member supporting recessed hinge |
| 252 | Butt joint between modules-floor |
| 253 | Strut in panels 242/243 |
| 254 | Double vertical strut supporting roof beam |
| 255 | Butt joint (union) between roof panels |
| 256 | Butt joint (union) between side walls where two modules |
| | join together |
| 257 | Exterior long edge of module base-outer edge of multiunit |
| | structure |
| 259 | Front wall/rear wall union between top and bottom panels of |
| | bifold or multifold wall |
| 260 | Tabs to anchor floor to concrete slab |
| 261 | Bracket for securing folded modules |
| 262 | Butt joint (union) between base support (119) and wall |
| | perimeter frame (170) when unfolded |
| 263 | Pin in butt hinge |
| 264 | Rubber bumpers for storage mode between horizontal wall |
| | panels. |
| 265 | Pallet holding stacked modules |
| 266 | Gap between a wall and base support for recessed hinges. |
| 268 | Interior cover over corner and bolts in FIGS. 4, 19 and 20. |
| 269 | Exterior corner |
| 269′ | Exterior corner of front module base |
| 269″ | Exterior corner of rear module base |

1. A modular foldable building structure (10) comprising:
a. at least one room unit (100) having a first foldable module (100′) and a second foldable module (100″), wherein each module has a storage position (238) and an erected position (FIG. 2), and each module has a base (110′, 110″) with a square or rectangular shape with an interior edge (224′, 224″) and three exterior edges (225′, 225″, 226′, 226″, 227′, 227″), and a floor (120) wherein each interior edge (224′, 224″) of the base is a joinable edge parallel to the exterior edge (225′, 225″) of the same module;
b. wherein each short edge (226′, 226″, 227′, 227″) has a side wall panel (140′, 140″, 160′, 160″) hingeably connected thereto, such that each side wall panel lays flat along the base in the storage position (238) and in an erected position, each side wall pivots upwards around a hinge to define a right angle between the floor and the wall;
c. wherein an optional bifold wall panel (130) having an axis of folding is hingeably attached to the exterior edge (225′, 225″) of either module wherein the axis of the bifold (259) is parallel to the floor, such that the bifold wall panel, if present, folds towards the joinable edge (224′, 224″) in the storage position and unfolds in the erect position to define a right angle between the floor and front wall panel in the erect position; and
d. wherein the first foldable module (100′) in the erected position and the second foldable module (100″) in the erected position are configured to couple together along the joinable edge (224′, 224″) of each module to form a unit body (100) with a rectangular or square-shaped floor, and wherein a roof (200) that at least covers the floor (120) is affixed to a support member (177), to form a modular foldable building structure.

2. A modular foldable building structure (10) comprising:
a. at least one room unit (100) having a first foldable module (100′) and a second foldable module (100″), wherein each module has a storage position (238) and an erect position (FIG. 2), and each module has a base (110′, 110″) with a square or rectangular shape with an interior edge (224′, 224″) and three exterior edges (225′, 225″, 226′, 226″, 227′, 227″), and a floor (120) defined by floor panels (120′, 120″) covering each module base, wherein each interior edge (224′, 224″) of the base is a joinable edge parallel to an exterior edge (225′, 225″) of the same module;
b. wherein an optional bifold wall panel (130) is hingeably attached to each exterior edge (225′, 225″), wherein an axis of the multifold wall (259) is parallel to the floor such that the multifold wall panel, if present, folds towards the joinable edge (224′, 224″) in the storage position and unfolds in the erect position to define a right angle between the floor and front wall panel;
c. wherein an exterior edge (226′, 226″, 227′, 227″) is a side edge of the square or rectangular shaped module wherein a side wall (140′, 140″, 160′, 160″) is hingeably connected to a side edge (226′, 226″, 227′, 227″), such that each side wall lays flat along the base in the storage position (238), and in an erected position, each side wall pivots upwards around a hinge to define a right angle between the floor and the wall; and
d. wherein the first foldable module (100′) in the erect position and the second foldable module (100″) in the erect position are configured to couple together along the joinable edges (224′, 224″) of each module to form a unit body (100) with a rectangular or square-shaped floor, and wherein a roof (200) that at least covers the floor (120) is affixed to a roof support member (177), to form a modular foldable building structure.

3. A modular foldable building structure (10) comprising:
a. at least one room unit (100) having a first foldable module (100′) and a second foldable module (100″), wherein each module has a storage position (238) and an erected position (FIG. 2), and each module has a base (110′, 110″) with a square or rectangular shape with an interior edge (224′, 224″) and three exterior edges (225′, 225″, 226′, 226″, 227′, 227″), and a floor panel (120′, 120″) covering each module base, wherein each interior edge (224′, 224″) of the base is a joinable edge parallel to the exterior edge (225′, 225″) of the same module;
b. wherein each short edge (226′, 226″, 227′, 227″) may have a side wall panel (140′, 140″, 160′, 160″) hingeably connected thereto, such that each side wall, if present, lays flat along the base in the storage position (238) and in an erected position, each side wall pivots upwards around a hinge to define a right angle between the floor and the wall, and wherein each module (100′ or 100″) has at least two side walls (140′, 140″, 160′, 160″);
c. wherein an optional bifold wall panel (130) is hingeably attached to the exterior edge (225′, 225″) of either module wherein the axis of the bifold is parallel to the floor, such that the bifold wall panel, if present, folds towards the joinable edge (224′, 224″) in the storage position and unfolds in the erect position to define a right angle between the floor and front wall panel in the erect position; and
d. wherein the first foldable module (100′) in the erected position and the second foldable module (100″) in the erected position are configured to couple together along the joinable edge (224′, 224″) of each module to form a unit body (100) with a rectangular or square-shaped floor, and wherein a roof (200) that at least covers the floor (120) is affixed to a support member (177), to form a modular foldable building structure.

4. A modular foldable building structure (30) comprising:
a. a room unit having a first and second foldable module (100′, 100″) having a storage position (238) and an erected position, where each module has a first module base (110′, 110″) having a square or rectangular shape with an interior edge (224′, 224″) and three exterior edges (225′, 225″, 226′, 226″, 227′, 227″), a floor panel covering the first module base, wherein one long edge of each base is a joinable edge (224′, 224″) and the other long edge of the base defines a long exterior edge (225′, 225″) with two exterior corners (269), wherein each short edge (227) has an open side wall (240) hingeably connected to the corner (269) of the short edge, such that the side wall lays flat along the base in the storage position, and each side wall pivots upward in the erected position to define a right angle between the base and the wall when erect, and wherein the side wall (240) has a vertical support member (241) and an upper side panel (242); and
b. wherein the first foldable module in the erected position and the second foldable module in the erected position are configured to couple together along the joinable edge (224) of each module to form a unit body 100 with a rectangular or square-shaped floor, and a long edge upper panel (243) is placed between the two upper side panels (242), and wherein a roof (200) that at least covers the floor (120) is affixed to a support beam (177), to form a modular foldable building structure.

5. The modular foldable building structure according to any of claims 1-4, wherein the roof comprises one or more roof panels (200′, 200″), and said roof panels are mounted on the room unit to form a habitable space with at least one door opening.

6. The modular foldable building structure according to any of claims 1-4, wherein the support member is an I-beam (177a).

7. The modular foldable building structure according to any of claims 1-4, wherein the support member is a hollow tube having at least a flat surface upper surface affixable to the roof panels (177b).

8. The modular foldable building structure according to any of claims 1-4, wherein the roof panels are supported by two or more trusses (177c).

9. The modular foldable building structure according to any of claims 1-4, wherein the coupling of the first and second modules along the joinable edge (224) to form the room unit further comprises at least one joining part (162) having a bolt and nut (161) to fasten the two modules together.

10. The modular foldable building structure according to any of claims 1-4, wherein any wall (130, 140, 150, 160) further comprises a frame made of steel tubing, wood, rigid plastic, or other suitable construction materials.

11. The modular foldable building structure according to any of claims 1-4, wherein any wall (130, 140, 150, 160) further comprises one or more panels made of wood, sheet metal, rigid plastic, or other suitable construction materials.

12. The modular foldable building structure according to any of claims 1-4, wherein adjacent wall panels are connected together with at least one bolt (164) and nut.

13. The modular foldable building structure according to any of claims 1-4, wherein the hinges for each side wall comprise two outer knuckles (245) affixed to the base, and an inner knuckle (244) affixed to the wall, and pin 263 through the knuckles.

14. The modular foldable building structure according to any of claims 1-4, wherein the first or second module or both has a wall affixed to the exterior edge wherein the wall comprises one or more horizontal panels connected to each other by hinge mechanisms, and wherein said one or more horizontal panels fold and unfold with respect to each other along a horizontal axis.

15. The modular foldable building structure according to any of claims 1-4, wherein each wall is joined to another wall to form a corner, wherein the corner comprises a joint with at least one bolt, and the joined walls are locked into position.

16. The modular foldable building structure comprising a plurality of interconnected foldable room units according to any of claims 1-4, wherein one or more joined short edges (232) can be joined to form a plurality of interconnected foldable units.

17. The modular foldable building structure comprising a plurality of interconnected foldable room units according to any of claims 1-4, wherein one or more long edges (234) can be joined to form a plurality of interconnected foldable units.

18. The modular foldable building structure according to any of claims 1-4, wherein a wall has a window or door opening (158).

19. The modular foldable building structure according to any of claims 1-4, wherein a wall has large opening (236) and an upper panel (237).

20. The modular foldable building structure according to any of claims 1-4, wherein each wall has a frame (171, 172) and one or more panels.

21. The modular foldable building structure according to any of claims 1-4, wherein the floor of each module has a frame (123) and a solid floor selected from one or more floor panels (120), floor planking, or concrete.

22. The modular foldable building structure according to any of claims 1-4, wherein the floor and walls are insulated.

23. The modular foldable building structure according to any of claims 1-4, wherein an opening is provided in a wall section for air conditioning unit, and the air conditioning unit can cool or heat the air in the room unit.

24. The modular foldable building structure according to any of claims 1-4, wherein electrical fixtures and plumbing fixtures are provided.

25. The modular foldable building structure according to any of claims 1-4, further comprising one or more walls coupled to the first or the second module walls to extend the height of the structure.

26. The modular foldable building structure according to any of claims 1-4, wherein the structural members and all floor, wall, and roof panels are made from a material selected from steel, wood, or plastic or other suitable construction materials.

27. The modular foldable building structure according to any of claims 1-4, wherein each module is sufficiently light weight that in is carried into position by a team of two to six people.

28. A method of assembling a modular foldable unit according to any of claims 1-4, comprising the steps of:
a. Placing the first folded module at a desired position with the first module base facing the ground with or without supports on the ground or a foundation;
b. pivoting upwards (230) each wall panel of the first module to an erected position perpendicular to the base and securing each erected wall panel in the erected position;
c. placing a second module of a unit in contact with the first module, wherein the second module floor is level with the first module floor and is facing the ground with or without supports on the ground or a foundation;
d. pivoting upwards the wall panels of the second module to an erected position perpendicular to the base and securing the wall panels in the erected position;
e. attaching the first module to the second module by attaching each side wall panel of the first module to an adjacent side wall panel of the second module;
f. installing a roof supporting member into a pocket formed by the attachment of the side wall panel of the first module to the adjacent side wall panel of the second module; and
g. attaching the roof panels to the roof supporting member.
